(19) United States
(12) Patent Application Publication
(10) Pub. No.: US 2025/0250705 A1
(43) Pub. Date: Aug. 7, 2025

(54) SYSTEMS AND METHODS FO RMETAL PRODUCTION FROM BRINE SOLUTIONS

(71) Applicant: c/o ENERGY EXPLORATION TECHNOLOGIES, INC., Austin, TX (US)

(72) Inventors: Nicholas S. GRUNDISH, Austin, TX (US); Angelo KIRCHON, Austin, TX (US); Richelle LYNDON, Austin, TX (US); David KAPLIN, Austin, TX (US); Amit PATWARDHAN, Austin, TX (US); Jongwook MAH, Austin, TX (US)

(73) Assignee: c/o ENERGY EXPLORATION TECHNOLOGIES, INC., Austin, TX (US)

(21) Appl. No.: 18/854,115

(22) PCT Filed: Apr. 4, 2023
(86) PCT No.: PCT/US2023/017489

§ 371 Date: Oct. 4, 2024

Related U.S. Application Data
(60) Provisional application No. 63/327,231, filed on Apr. 4, 2022.

(51) Int. Cl. C25C 1/02; B01J 20/02; B01J 20/34; C22B 3/24; C22B 26/12; C25C 7/02

(52) U.S. Cl. CPC C25C 1/02; B01J 20/0292; B01J 20/3433; B01J 20/3441; C22B 3/24; C22B 26/12; C25C 7/02

(57) ABSTRACT

Method(s) and system(s) for the direct production of lithium and other metals from a brine solution containing salts of various metal cations at room temperature via a combined sorbent extraction and electrochemical extraction/plating process. This process uses a skeleton structure material that can reversibly insert/extract a desired metal cation to absorb the desired metal ions from a brine solution. The metal impregnated skeleton structure material is then transferred to an electrochemical cell where the metal ions are extracted from the structure and plated in the form of metal onto an electronically conductive substrate. This process is a combination of methods to take metal ions directly from a brine solution to produce an end-product of metal and is a significant improvement over current industrial processes that will reduce the energy required for metal production.

This application claims the benefit of priority to U.S. Provisional Application No. 63/327,231, filed on Apr. 4, 2022 the entire content of which are hereby incorporated by reference.

### BACKGROUND

### 1. Technical Field

The present disclosure generally relates to a method for producing metal at or near room-temperature. More specifically, the present disclosure relates to a method for producing metal from a brine solution at or near room-temperature.

### 2. Description of Related Art

For lithium, typical commodities are lithium hydroxide monohydrate (also loosely referred to as lithium hydroxide or LiOH) and lithium carbonate (Li₂CO₃). Both chemicals are industrially important as precursor chemicals to lithium-ion battery cathode materials. With the growing demand and production of electric vehicles, not only is the demand for these commodities growing, but a market for lithium in its metallic form has emerged. This sudden demand stems from the emergence of next-generation battery chemistries that enable lithium metal to be used as an anode in secondary lithium batteries with energy and power densities that are higher than current lithium-ion technology. However, the current production methods for lithium metal must be improved to meet the upcoming demand for lithium metal to meet production targets of these battery chemistries as they become commercialized.

Currently, a molten salt electrolytic process is used to produce lithium metal and many of its alloys. The electrolytic cell that this process is performed in consists of a stainless-steel cathode, a graphite anode, and a eutectic KCl—LiCl electrolyte. This process is performed at ˜400-500° C. and yields a lithium metal of greater than 97% purity. The high temperature required to perform the electrolytic process is energy intensive and the counter reaction to the formation of lithium metal at the cathode is the evolution of an undesirable highly toxic chlorine gas (Cl₂) as a byproduct. Other alkali or alkaline earth metals require high temperature processing, such as molten salt electrolysis for potassium, carbothermal reduction for sodium, or a silicothermic process for magnesium.

### SUMMARY

The present disclosure provides methods and systems to directly produce a metal from a brine solution consisting of solvated salts with various cations and anions. A skeleton or framework material is inserted into a brine solution, where it accepts metal-ions, such as lithium-ions, and then it is placed into a compatible electrolyte solution where the metal-ions can be removed and plated as a metal onto a substrate, such as lithium metal on copper. This process can use any skeleton or framework structure that can reversibly intercalate/deintercalate the metal-ions of interest and is stable in brine solutions as well as suitable electrolyte solutions. Additionally, this invention includes an apparatus for this process to take metal-ions selectively from a brine solution containing salts of a single or many different cations and plate it as a metal of interest such that the only input of the apparatus is a brine solution that contains metal-ions with any type of counter anions and the product output of the apparatus is metal. This process and the apparatus for performing this process can work in a batch or a continuous process.

For the case of lithium metal, further improvement to this system may yield battery grade lithium metal—possibly in a roll-to-roll fashion, and possibly in an acceptable form for use as a lithium battery anode. For now, the initial idea is to produce a crude (>90% purity) lithium metal from a lithium brine solution. These further improvements to yield battery grade lithium metal may also be applied to produce other high purity metals of interest for secondary battery applications, such as sodium, potassium, or magnesium metal.

Other objects, features and advantages of the present disclosure will become apparent from the following detailed description. It should be understood, however, that the detailed description and the specific examples, while indicating specific embodiments of the disclosure, are given by way of illustration only, since various changes and modifications within the spirit and scope of the disclosure will become apparent to those skilled in the art from this detailed description. Note that simply because a particular compound is ascribed to one particular generic formula doesn't mean that it cannot also belong to another generic formula.

### BRIEF DESCRIPTION OF THE DRAWINGS

So that the manner in which the features, advantages and objects of the disclosure, as well as others which may become apparent, are attained and can be understood in more detail, more particular description of the disclosure briefly summarized above may be had by reference to the embodiment thereof which is illustrated in the appended drawings, which drawings form a part of this specification. It is to be noted, however, that the drawings illustrate only example embodiments of the invention and is therefore not to be considered limiting of its scope as the disclosure may admit to other equally effective embodiments.

FIG. 1. Overall schematic of the disclosed methods to go from brine to lithium metal with a reusable sorbent skeleton structure material.

FIG. 2. Schematic of one embodiment of the disclosed methods to go from brine to lithium metal with a reusable sorbent skeleton structure material.

FIG. 3. Schematic of one embodiment of the disclosed methods to go from brine to lithium metal with a reusable sorbent skeleton structure material.

FIG. 4. Detailed schematic of overall process taking lithium ions from a brine solution to the final product of lithium metal.

FIG. 5. Schematic of apparatus for continuous direct lithium metal production from brine solution.

FIG. 6. Schematic of apparatus for batch production of lithium metal directly from brine solution—this apparatus can be outfitted to enable a continuous process if many cells are strung together.

FIG. 7. Schematic of composite electrode matrix for embedding sorbent material and transferring between stages of extraction and metal plating processes.

FIG. 8. Isometric view of test cell setup for proof-of-concept experiments conducted in Example 2.

FIG. 9. Top view of test cell setup for proof-of-concept experiments conducted in Example 2.

FIG. 10. Front view of test cell setup for proof-of-concept experiment conducted in Example 2.

FIG. 11. Full experimental setup for proof-of-concept run performed in Example 2.

FIG. 12. The starting electronically conducting substrate—in this case copper foil—before the lithium metal plating step.

FIG. 13. The plated metal on the electronically conducting substrate—in this case lithium metal on copper foil.

FIG. 14. Scanning electron microscopy image of as purchased lithium metal produced via traditional manufacturing methods and rolled into an all-metal foil.

FIG. 15. Scanning electron microscopy image of a lithium metal anode plated on copped produced via the methods disclosed herein.

FIG. 16. X-Ray Photoelectron Spectra of an as purchased lithium metal produced via traditional manufacturing methods and rolled into an all-metal foil (T sample), and of the lithium metal anode deposited on copper produced via the methods disclosed herein.

FIG. 17. Cycle number versus specific capacity plot of a battery consisting of an LiFePO₄ based cathode, and a lithium metal anode produced via the methods disclosed herein.

### DETAILED DESCRIPTION OF THE EMBODIMENTS

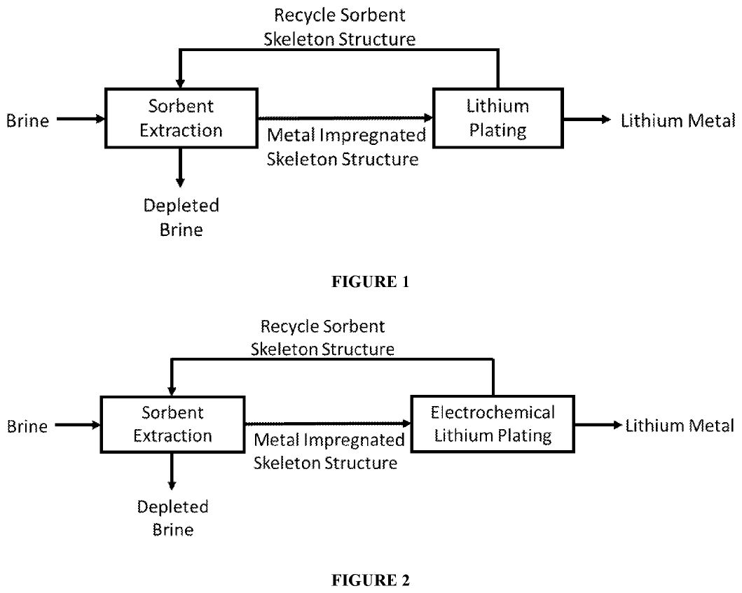

The present disclosure provides methods to produce metal directly from a brine solution, which is an aqueous solution consisting of salts of many different cations. The overall process and variations that serve as different embodiments to the methods disclosed are shown in FIGS. 1-3. For lithium, in contrast to the current industrial methods of lithium metal production, which must be performed at temperatures ranging from 400° C. to 500° C. and produce toxic chlorine gas (Cl_{2(g)}) as a byproduct, the disclosed method can be performed entirely at room temperature and does not produce any toxic byproducts. Additionally, the disclosed method requires an apparatus to perform the processes of sorbent extract in tandem with metallic electrodeposition in a continuous fashion. This process can be performed to yield any metal of interest if the starting brine solution contains metal cations of the particular metal of interest. Metals that this process can be extended to include, but are not limited to sodium, potassium, or magnesium.

The combination of sorbent extraction into the electrodeposition of metals in a nonaqueous media requires a skeleton structure material that can reversibly insert/extract ions of the final desired metal. For the purpose of producing metal from a brine solution, the sorbent skeleton material must be able to reversibly insert/extract metal ions. The sorbent skeleton material must be stable in and be able to insert metal ions in an aqueous brine solution. Additionally, owing to the reactivity of some potential final metal products, such as lithium metal, the metal-impregnated sorbent skeleton material must be stable in a nonaqueous electrolyte media and have the ability for the metal-ions to be electrochemically extracted from it. For the purposes of description, the case of lithium metal production will be discussed for the remainder of this disclosure with the understanding that it can be substituted for any metal of interest with cations present in the starting brine solution.

The mechanism of sorbent extraction where lithium ions are inserted into a skeleton material in a brine solution can consist of, but is not limited to, a concentration driven insertion, a chemical reduction/oxidation reaction, an electrochemical reduction/oxidation reaction, or a combination thereof. Sorbent skeleton structures refers to a crystalline material with the ability to insert/extract lithium ions selectively over other ions present in brine solutions such as sodium, potassium, magnesium, and calcium. These materials may further comprise a transitional metal complex that forms a framework using a coordinate complex that allows for the selective binding of a lithium ion. In some embodiments, these complexes may preferentially bind lithium ions over other ions such as calcium ions, magnesium ions, potassium ions, or sodium ions. In other embodiments, these sorbent skeleton structures may be one started with lithium complexed to the sorbent skeleton structure and then have the lithium removed through a delithiating methods that provide a sorbent structure that can then readily uptake new lithium ions from a brine solution. Organic or inorganic materials that may serve this purpose include but are not limited to organosulfur compounds, carbonyl compounds, imine compounds, anatase TiO₂, rutile TiO₂, Li₄Ti₅O₁₂, LiFePO₄ and TiNb₂O₇. Additionally, the sorbent skeleton material can consist of a material that is synthesized with lithium already in it to the fullest capacity of the crystalline structure, but in this case a delithiation step is required prior to use of the material as a sorbent skeleton material. The sorbent skeleton material is used in the sorbent extraction step, then it is washed and dried to prevent contamination of the nonaqueous electrolyte media that is required for the final step in the process. After washing and drying, the lithiated skeleton structured material is placed in a nonaqueous electrolyte solution where the lithium ions are extracted from the skeleton sorbent material and plated onto an electronically conductive substrate. The method of lithium extraction in this nonaqueous electrolyte media can include, but is not limited to, a concentration driven reaction, a pressure driven reaction, a chemical reduction/oxidation reaction, an electrochemical reduction/oxidation reaction, or a combination thereof.

The final lithium metal product of the disclosed method may be further processed to produce battery grade lithium metal. This battery grade lithium metal may be further processed to produce a lithium metal anode for a primary or secondary lithium battery. The disclosed process may also be tailored to directly produce battery grade lithium metal and/or a lithium metal anode that may be used directly in a primary or secondary lithium battery. Such primary or secondary lithium battery chemistries that may be able to use a lithium metal anode made directly with the disclosed process include, but are not limited to Li—MnO₂ batteries, Li—O₂ batteries, Li—S batteries, rechargeable lithium metal batteries with an Li[NiₓMn_{y}Co_{z}]O₂ (x+y+z=1), Li[NiₓCo_{y}Al_{z}]O₂ (x+y+z=1), Li[NiₓMn_{y}]O₂ (x+y=1), Li[LiₓNi_{y}Mn_{z}]O₂ (x+y+z=1), or LiFePO₄ cathode, hybrid lithium metal batteries, or all-solid-state lithium metal batteries. The process can be tailored to produce high grade lithium metal or directly produce lithium metal anodes through the formulation of the nonaqueous solvent with a solvated lithium conducting salt used for extracting lithium ions from the sorbent skeleton structure and plating them onto an electronically conductive substrate.

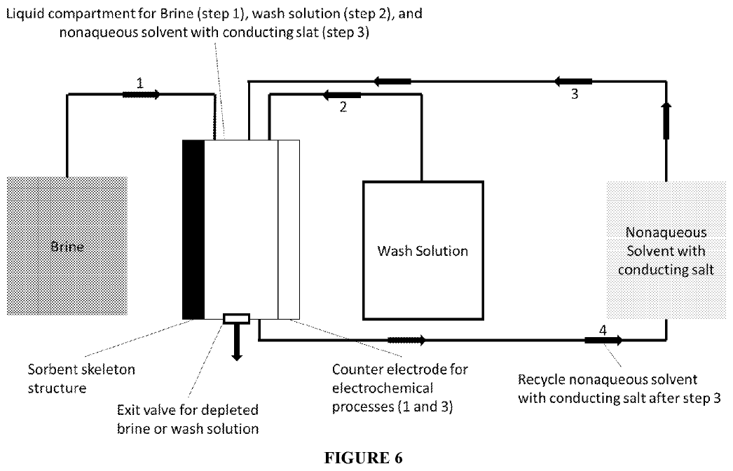

Owing to the unique nature of the combined methods disclosed, new apparatuses must be constructed to perform the process from start to finish in either a continuous or batch process. FIG. 5 shows a schematic of an apparatus that can enable a continuous process to produce lithium metal from a brine solution, possibly in a roll-to-roll fashion. In this apparatus, the sorbent skeleton material is transferred between a brine solution and a nonaqueous solvent with a lithium conducting salt. A wash bath and a drying step is placed between each of the two primary tanks—the brine tank and the nonaqueous solvent tank—to prevent contamination of either system with each other. In this design, the brine solution is the only aspect that must be replenished during use as a lithium source must continuously be available. However, even this brine replenishment can be made to be a continuous process with a suitable pump system. FIG. 6 shows an apparatus that would enable a batch process of the methods described herein. In this apparatus, the sorbent skeleton structure remains stagnant while the necessary liquid—either brine solution, wash solution, or a nonaqueous solvent with a conducting salt—is passed into the apparatus depending on which process step is occurring. A counter electrode is passed into the cell as needed when deposition of lithium metal is occurring. The nonaqueous solvent can be recycled in this apparatus design.

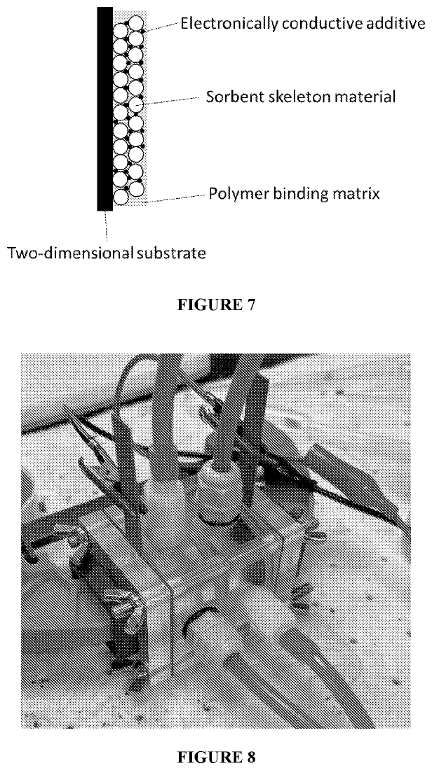

The manner in which the sorbent skeleton structure is transferred or placed into the apparatus is dependent on the desired throughput for the process. In one embodiment of the methods and apparatuses, the sorbent skeleton material may be embedded with an electronically conductive additive—such as carbon black, graphene, or reduced graphene oxide—and a polymer binding agent—such as polyvinylidene fluoride (PVDF) or polytetrafluoroethylene (PTFE). Some non-limiting examples of the electronically conductive additive include 0-50 wt %. Similarly, non-limiting examples of the polymer binding agent include 0-30 wt %. Additionally, this composite may be cast onto a substrate. This substrate may either be a two-dimensional substrate, such as a metallic foil, or a three-dimensional substrate, such as a metallic foam. FIG. 7 demonstrates a schematic of one embodiment where a composite of the sorbent skeleton material, an electronically conductive additive, and a polymer binder are casted onto a two-dimensional metallic foil substrate for use in either of the apparatuses shown in FIG. 5 and FIG. 6.

The Specification, which includes the Summary, Brief Description of the Drawings and the Detailed Description, and the appended Claims refer to particular features (including process or method steps) of the disclosure. Those of skill in the art understand that the invention includes all possible combinations and uses of particular features described in the Specification. Those of skill in the art understand that the disclosure is not limited to or by the description of embodiments given in the Specification.

Those of skill in the art also understand that the terminology used for describing particular embodiments does not limit the scope or breadth of the disclosure. In interpreting the Specification and appended Claims, all terms should be interpreted in the broadest possible manner consistent with the context of each term. All technical and scientific terms used in the Specification and appended Claims have the same meaning as commonly understood by one of ordinary skill in the art to which this invention belongs unless defined otherwise.

As used in the Specification and appended Claims, the singular forms “a,” “an,” and “the” include plural references unless the context clearly indicates otherwise. The verb “includes” and its conjugated forms should be interpreted as referring to elements, components or steps in a non-exclusive manner. The referenced elements, components or steps may be present, utilized or combined with other elements, components or steps not expressly referenced. The verb “operatively connecting” and its conjugated forms means to complete any type of required junction, including electrical, mechanical or fluid, to form a connection between two or more previously non-joined objects. If a first component is operatively connected to a second component, the connection can occur either directly or through a common connector. “Optionally” and its various forms means that the subsequently described event or circumstance may or may not occur. The description includes instances where the event or circumstance occurs and instances where it does not occur.

Conditional language, such as, among others, “can,” “could,” “might,” or “may,” unless specifically stated otherwise, or otherwise understood within the context as used, is generally intended to convey that some implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

The systems and methods described herein, therefore, are well adapted to carry out the objects and attain the ends and advantages mentioned, as well as others inherent therein. While example embodiments of the system and method have been given for purposes of disclosure, numerous changes exist in the details of procedures for accomplishing the desired results. These and other similar modifications may readily suggest themselves to those skilled in the art and are intended to be encompassed within the spirit of the system and method disclosed herein and the scope of the appended claims.

### Example 1: Olivine FePO₄ as a Sorbent Skeleton Material for Lithium Metal Production from an Aqueous Brine Solution

In one embodiment of the present invention, LiFePO₄ can be chemically delithiated to from an FePO₄ skeleton structure that can serve as a vehicle to take lithium ions from a brine solution and turn them into lithium metal. To form the correct crystalline structure to reversibly insert/extract lithium ions into it, FePO₄ must be synthesized with lithium pre-existing in it as LiFePO₄. Thus, for this proof-of-concept experiment, 31.56 g (0.2 mols) of LiFePO₄ was chemically delithiated to FePO₄ by mixing the starting LiFePO₄ in an aqueous solution with 27.032 g (0.01 mol) potassium persulfate (K₂S₂O₈). The solution was mixed for 24 hours to ensure that structure was fully delithiated. The now chemically delithiated FePO₄ was allowed to settle to the bottom of the solution for 30 minutes and the powder was collected to be tested for lithiation in a real brine solution. The chemically delithiated FePO₄ was then put into a real brine solution and Na₂S₂O₃ was added as a reagent to get lithium ions from the brine solution to insert into the FePO₄ structure, reforming LiFePO₄. Proof of lithiation of the FePO₄ sorbent skeleton material absorbed lithium from the brine solution was tested with inductively coupled plasma-optical emission spectroscopy (ICP-OES) to observe the lithium concentration in the brine solution before and after the FePO₄ brine lithiation process.

The results from the ICP-OES tests are presented in Table 1 and provide empirical proof that the chemically delithiated FePO₄ reabsorbed lithium ions when placed into a brine solution. The drastic decrease in lithium concentration after the brine lithiation procedure indicates that most of the lithium ions in the brine solution inserted into the FePO₄ skeleton sorbent material, reforming LiFePO₄. A primary concern in the extraction of lithium from brine solutions is the uptake of magnesium ions. For comparison, the magnesium content of the brine solution before and after the FePO₄ lithiation procedure are included in Table 1. The change in magnesium content in the brine before and after the FePO₄ sorbent extraction is considerably less than the change in lithium content, indicating that the chemically delithiated LiFePO₄ sorbent is extremely lithium selective. Other ions of lesser interest in lithium extraction of brine are sodium, calcium, and potassium—the concentration of these ions did not show any change of significance after the brine lithiation procedure. Therefore, the chemically delithiated FePO₄ is shown to be extremely lithium selective in its uptake of cations from the brine solution.

TABLE 1
Lithium insertion from brine solution into FePO₄ that was
chemically delithiated from as-synthesized LiFePO₄.

| | Mg content | Li content |
|---|---|---|
| Sample | [ppm] | [ppm] |
| Brine before FePO₄ chemical lithiation | 1361 | 862 |
| Brine after FePO₄ chemical lithiation | 1220 | 10 |

After the brine lithiation procedure, the chemically delithiated FePO₄ (now LiFePO₄ after the brine lithiation) can be washed and dried to remove any residual salts leftover from being submerged in the brine solution and transferred to an electrochemical cell to extract the lithium ions from the LiFePO₄ and plate them onto an electronically conductive substrate as lithium metal. The Example 1 provided embodies the system outlined in FIG. 2.

### Example 2: A Fully Electrochemical Process for Producing Lithium Metal from Brine Solutions with a Compatible Sorbent Skeleton Material

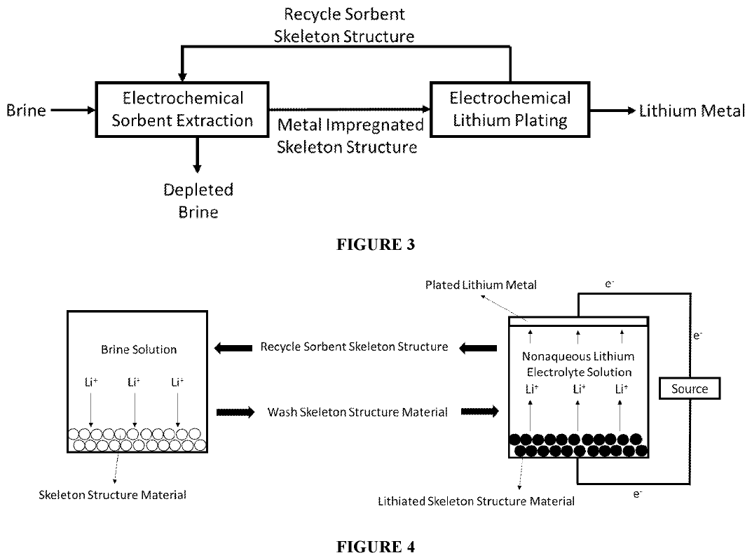

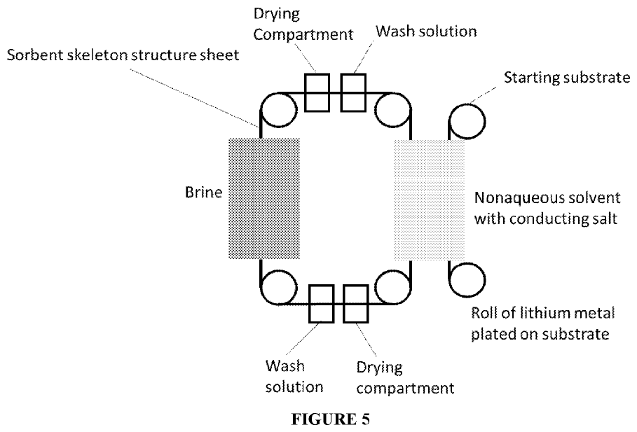

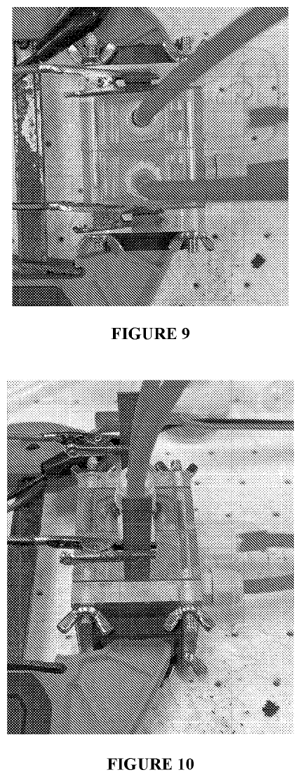

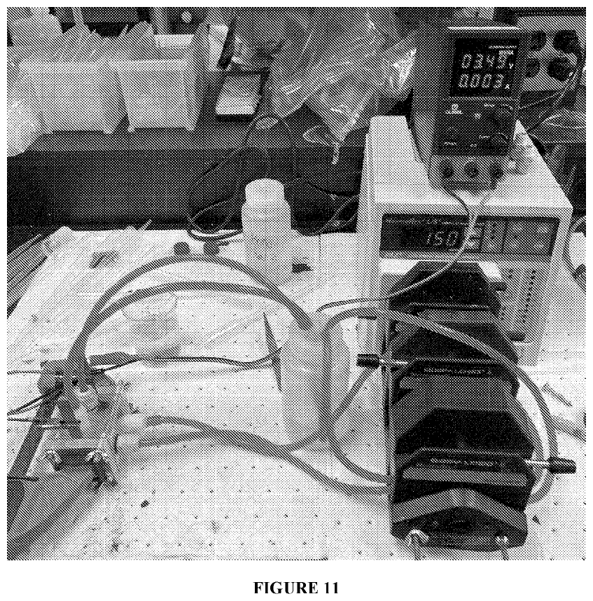

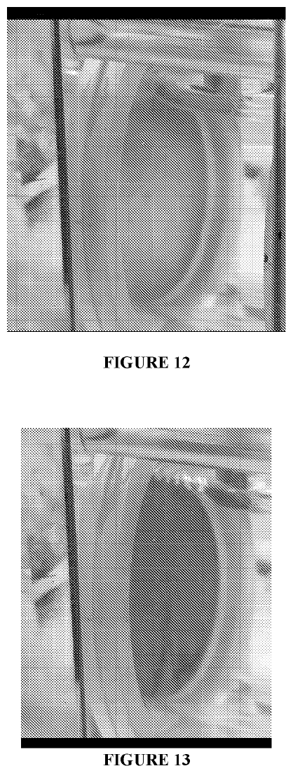

In one embodiment, as expressed in FIG. 3, the current disclosed methods can include sorbent extraction and lithium metal deposition processes that are performed electrochemically. Additionally, if the sorbent skeleton material is synthesized with as a lithium containing material, the initial delithiation can also be performed electrochemically. For the purposes of demonstration, LiFePO₄ is the starting material for this proof-of-concept experiment. The LiFePO₄ is integrated into an electrode composite consisting of an electronically conductive additive and a polymer binder material. Then the composite LiFePO₄ electrode is placed into an electrochemical cell as shown in FIG. 8-10 with a nonaqueous solvent containing a solvated lithium conducting salt. The LiFePO₄ electrode is then electrochemically delithitated to obtain an FePO₄ electrode. This FePO₄ electrode can then be placed into a brine solution and electrochemically lithiated. This re-lithiated LiFePO₄ electrode can then be placed again into a nonaqueous electrolyte solution to electrochemically extract the lithium ions from the LiFePO₄ structure and plate them onto an electronically conductive substrate. Practically, for this demonstration, the electrochemical cell was filled with nonaqueous solvent with a solvated lithium conducting salt for the initial electrochemical delithiation step, filled with brine for the sorbent skeleton extraction step, then the cell was washed with a cleaning solvent as to not contaminate the cell for the final extraction and plating step that was performed in a fresh bath of nonaqueous solvent with a solvated lithium conducting salt. The full experimental set up for this series of tests is provided in FIG. 11. A power supply was used to supply constant voltage across the cell for all electrochemically driven steps. The starting electronically conducting substrate—in this case copper foil—before the lithium metal plating step is shown in FIG. 12. The plated metal on the electronically conducting substrate—in this case lithium metal on copper foil—is shown in FIG. 13. Table 2 shows the analytical results of a few cycles performed with the method(s) and system(s) described herein. The concentration of lithium in the brine lowered upon each cycle of performing the sorbent extraction and subsequently plating lithium metal from the lithiated sorbent material in a separate nonaqueous solvent bath with a lithium conductive salt. The weight and thickness of the lithium metal plated after each cycle is also provided in Table 2 and shows that extremely thin lithium metal can be produced. The thickness and weight of the final metal product produced during each cycle can be further tailored through the amount of sorbent skeleton material used in the production run.

TABLE 2
Results from proof-of-concept experiment with a chemically
delithiated LiFePO₄ − olivinc FcPO₄− skeleton structure to
produce lithium metal directly from brinc solution.

| | Brine | Lithium | Thickness |
|---|---|---|---|
| | Lithium (Li) | Metal Plated | of Li Metal |
| Cycle | Concentration | Per Cycle | Plated on Copper |
| Starting Brinc | 14,135 ppm | N/A | N/A |
| After Cycle 1 | 13,827 ppm | 1.48 mg | 4.51 μm |
| After Cycle 2 | 12,214 ppm | 1.71 mg | 5.21 μm |
| After Cycle 3 | 11,338 ppm | 1.18 mg | 3.59 μm |

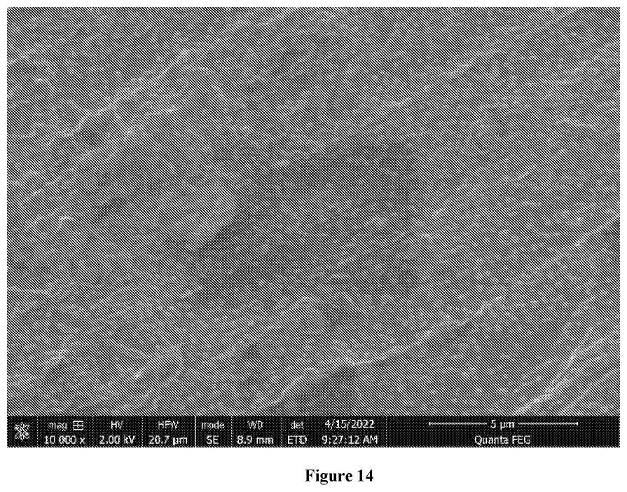

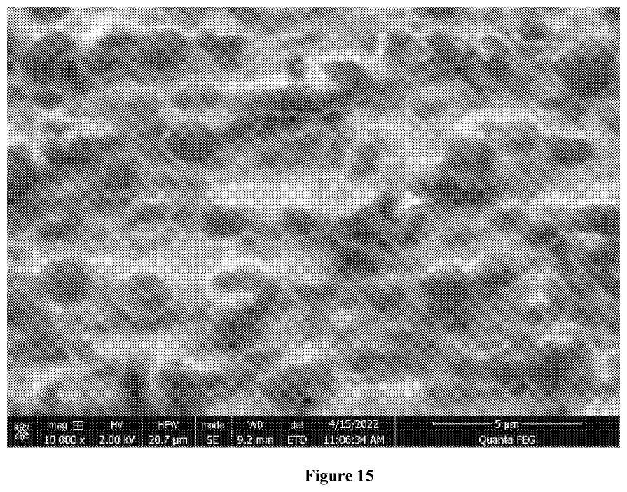

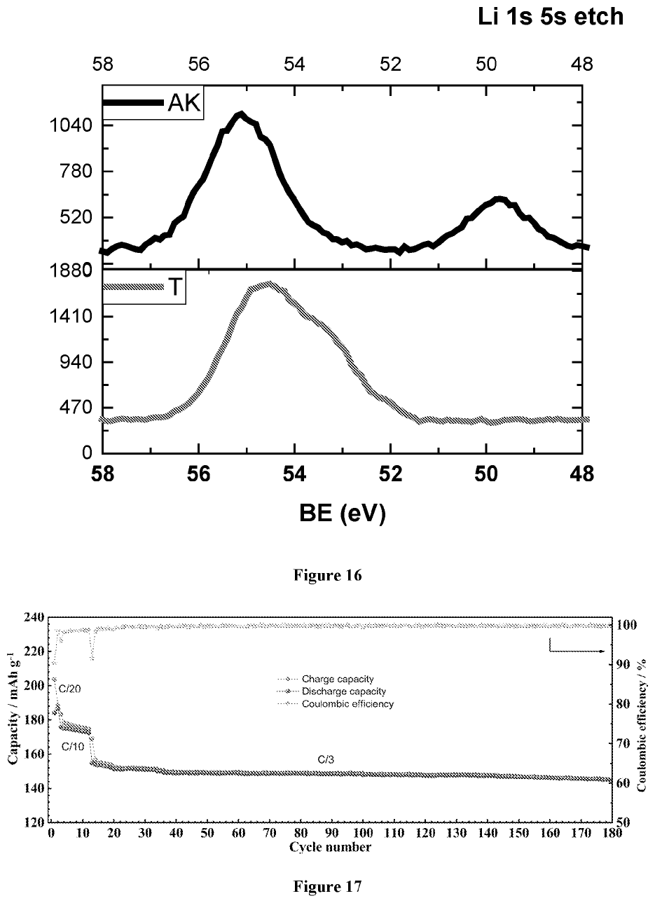

FIG. 14 shows the morphology of the lithium metal produced with conventional molten salt electrolysis methods that has been calendared into a free-standing foil. Even with extensive processing, the surface still is not completely smooth and the inhomogeneities provide nucleation sites for dendritic lithium when cycled in a battery. The lithium metal produced with the disclosed method (FIG. 15) shows extremely large grains which is indicative of dense lithium metal platting and beneficial for use in a secondary lithium metal battery. Further spectroscopic evidence of that the metal platted is indeed lithium metal, rather than another metal with similar optical qualities, is provided in FIG. 16. FIG. 16 shows X-ray photoelectron spectroscopy (XPS) spectra for the as purchased lithium metal sample shown in FIG. 14 (sample T) and for the lithium metal anode produced with the disclosed method (sample AK). The similarity of the major peaks around −55 eV demonstrate the presence of metallic lithium in both samples with other peaks present likely owing to surface contamination or alternative lithium products produced when the lithium metal has been exposed to various conditions. These additional peaks are prevalent since XPS is a surface sensitive technique that probes the binding states of chemical species within the first 5-10 nanometers of the sample.

To demonstrate the viability of the viability of the lithium metal anode product produced with the disclosed methods, a coin cell was prepared with this lithium metal and a commercial LiFePO₄ composite cathode. The cycling of this coin cell is shown in FIG. 17—the cell was started with a low current rate of C/20 and then iteratively take to a terminal rate of C/3 for extended cycling. The cell showed stable cycling and a high coulombic efficiency for the duration of the constant current cycling experiment. Therefore, it is shown that the lithium metal anode product produced with the current method can serve as a viable anode in a secondary lithium cell, and if optimized can enhance the performance metrics of secondary lithium metal batteries as expected for cells that incorporate a lithium metal anode instead of a traditional graphite anode.

What is claimed is:

1. A method for preparing a high purity metal comprising:
(A) exposing a brine solution to a sorbent material that absorbs the metal ions to form a metal-impregnated sorbent material; and
(B) exposing the metal-impregnated sorbent material with an electrical current to obtain the high purity metal and a metal depleted sorbent material.

2. The method of claim 1, wherein the metal-impregnated sorbent material is prepared using a chemical electrochemical process.

3. The method of claim 1, wherein the metal-impregnated sorbent material is prepared using a concentration driven process.

4. The method of claim 1, wherein the metal-impregnated sorbent material is prepared using a pressure driven process.

5. The method according to any one of claims 1-4, wherein the brine solution contains at least 0.3 ppm lithium.

6. The method of claim 5, wherein the brine contains one or more impurity metal salts, wherein the impurity metal salt is different from the metal ions.

7. The method of claim 6, wherein the brine solution contains an impurity metal salt is selected from a lithium salt, calcium salt, a magnesium salt, a sodium salt, a potassium salt, a cesium salt, a boron salt, a barium salt, a strontium salt, or a combination thereof.

8. The method according to any one of claims 1-7, wherein the sorbent material is a solid material.

9. The method of claim 8, wherein the sorbent material is a solid organic material.

10. The method of claim 8, wherein the sorbent material is a solid inorganic material.

11. The method according to any one of claims 1-10, wherein the sorbent material is a lithium intercalating material.

12. The method of claim 11, wherein the lithium intercalating material is an iron phosphate.

13. The method of claim 12, wherein the lithium intercalating material is olivine structured FePO₄.

14. The method according to any one of claims 1-13, wherein the sorbent material is in the solid phase.

15. The method of claim 14, wherein the sorbent material has a preference for lithium ions over other metal ions of at least 10:1.

16. The method of claim 15, wherein the preference of the sorbent material is at least 100:1.

17. The method according to any one of claims 1-16, wherein the sorbent material is affixed to a surface.

18. The method according to any one of claims 1-17, wherein the sorbent material is generated after exposure to a monovalent or divalent metal depleting solution.

19. The method of claim 18, wherein the metal depleting solution is a metal sulfate.

20. The method of claim 19, wherein the metal sulfate is potassium persulfate.

21. The method according to any one of claims 1-20, wherein the sorbent material is exposed to the brine with an absorption assisting agent.

22. The method of claim 21, wherein the absorption assisting agent is a thiosulfate salt.

23. The method of either claim 21 or claim 22, wherein the absorption assisting agent is a sodium thiosulfate.

24. The method according to any one of claims 1-23, wherein the metal-impregnated sorbent material is incorporated into a composite that comprises a conductive material.

25. The method of claim 24, wherein the conductive material is 0-50 wt %.

26. The method according to any one of claims 1-25, wherein the metal-impregnated sorbent material is incorporated into a composite that comprises a polymer binder.

27. The method of claim 26, wherein the polymer binder is 0-30 wt %.

28. The method according to any one of claims 1-27, wherein the metal impregnated sorbent material is formulated into an electrode.

29. The method according to any one of claims 1-28, wherein the metal-impregnated sorbent material is placed in a solution with a solvent and an electrolyte.

30. The method of claim 29, wherein the solvent is a nonaqueous solvent.

31. The method of either claim 29 or claim 30, wherein the electrolyte is a solvated metal-ion conducting salt.

32. The method according to any one of claims 1-31, wherein the electrical current is passed between the metal-impregnated sorbent material and a second electrode.

33. The method of claim 32, wherein the second electrode allows for deposition of metal.

34. The method of claim 33, wherein the second electrode is capable of plating metal.

35. The method according to any one of claims 1-34, wherein the method is configured to allow continuous deposition of metal.

36. The method according to any one of claims 1-34, wherein the method is configured to allow for the metal to be deposited on a substrate.

37. The method according to any one of claims 1-36, wherein the method allows for deposition in a roll-to-roll format.

38. The method according to any one of claims 1-37, wherein the method comprises washing the monovalent or divalent metal depleted sorbent material with a washing solution to obtain a purified depleted sorbent material.

39. The method of claim 38, wherein the washing solution is ethanol or water.

40. The method according to any one of claims 1-39, wherein the method further comprises drying the purified depleted sorbent material to obtain a dry purified depleted sorbent material.

41. The method according to any one of claims 1-40, wherein the method comprises exposing the delithiated sorbent material to a second brine solution.

42. An apparatus for preparing metal comprising:
(A) a sorbent material;
(B) a first chamber, wherein the first chamber contains one or more sealable openings to introduce fluid;
(C) an electrode for depositing metal; and
(D) an electrical source.

43. The apparatus of claim 42, wherein the sorbent material is deposited onto a second electrode.

44. The apparatus of either claim 42 or claim 43, wherein the sealable opening is configured to fill the first chamber with brine.

45. The apparatus according to any one of claims 42-44, wherein the scalable opening is configured to empty the first chamber of brine.

46. The apparatus according to any one of claims 42-45, wherein the sealable opening is configured to introduce a nonaqueous solvent.

47. The apparatus of claim 46, wherein the nonaqueous solvent further comprises an electrolyte.

48. The apparatus according to any one of claims 42-47, wherein the electrode, the second electrode, and the energy source are configured to allow energy to flow to the electrode and the second electrode from the energy source.

49. The apparatus according to any one of claims 42-48, wherein the apparatus further comprises a second chamber.

50. The apparatus of claim 49, wherein the second electrode is configured to rotate between the chamber and the second chamber.

51. The apparatus of either claim 49 or claim 50, wherein the second electrode is configured to pass through a washing solution between the chamber and the second chamber.

52. The apparatus according to any one of claims 42-51, wherein the first chamber is configured to introduce a washing solution into the chamber.

53. The apparatus of claim 52, wherein the first chamber is configured to remove the washing solution from the chamber.

54. The apparatus according to any one of claims 42-53, wherein the electrode is configured to allow continuous metal plating.

55. The apparatus according to any one of claims 42-53, wherein the electrode is configured to allow metal plating in a roll to roll process.

56. The apparatus according to any one of claims 42-55, wherein the second electrode further comprises an additive to enhance the electronic conductivity of the composite.

57. The apparatus according to any one of claims 42-56, wherein the second electrode further comprises a polymer binder.

58. The apparatus according to any one of claims 42-57, wherein the apparatus further comprises an element configured to dry the sorbent material.
